(19) United States
(12) Patent Application Publication
(10) Pub. No.: US 2004/0027695 A1
(43) Pub. Date: Feb. 12, 2004

(54) Adjustable dual function mirror with video display

(76) Inventor: William Lin, San Jose, CA (US)

Correspondence Address: Fortune Law Group LLP, Suite 315, 100 Century Center Court, San Jose, CA, 95112, US

(21) Appl. No.: 10/421,255

(22) Filed: Apr. 22, 2003

Related U.S. Application Data
(63) Continuation-in-part of application No. 10/214,013, filed on Aug. 6, 2002.

(51) Int. Cl. G02B 5/08; G02B 5/26; G02B 27/14

(52) U.S. Cl. 359/839

(57) ABSTRACT

An adjustable dual function mirror includes a plate including a smooth surface and a video display device disposed in spaced relationship to the plate, the plate and video display device being rotatable about at least one axis.

### RELATED APPLICATIONS

This application is a continuation in part of application Ser. No. 10/214,013 filed on Aug. 6, 2002 by William Lin.

### BACKGROUND OF THE INVENTION

This invention relates generally to dual function mirrors and more particularly to a dual function mirror operable to function either alternatively or simultaneously as an ordinary reflective mirror and a video display under a variety of ambient lighting conditions.

U.S. Pat. No. 5,956,181 to William Lin, hereinafter referred to as the “Lin Patent” discloses a two way, rear view mirror suitable for providing alternatively or simultaneously both a conventional reflected image and a video image. A preferred embodiment comprises a flat transparent plate coated with or glued with a reflective film mounted within a casing which provides support for the mirror and a mounting space for at least one video display monitor with a built-in light source mounted in the casing and positioned directly behind the reflective film to receive and display images received from a variety of information sources.

With reference to FIG. 1A, a dual function mirror segment 1 of the prior art is constructed of a flat transparent plate 4, which may be either a glass plate or a plastic plate, on a backside of which is placed a translucent reflective film 5 made of either silver or aluminum. On the back side of the flat transparent plate 4 is mounted a casing 8 made of solid plastic or metal materials, in conjunction with a metal clip 8a, to hold the dual function mirror segment 1 along the circumference of the dual function mirror segment 1 which may be mounted to a surface by a support column 9.

The casing 8 is mounted to the dual function mirror segment 1 in such a way that a space is provided to accommodate a video display device 2 which is mounted in and enclosed entirely inside the casing 8 and placed directly behind the translucent reflective film 5. The video display device 2 has a display screen 7 at its front side for image display and a backside 6 from where a lead wire (not shown) leaves the rear of the video display device 2 through suitable openings on the casing 8 to connect to a source of electrical power and ground. It is noted that the translucent reflective film 5 can be placed in a variety of locations, for example at a front side of the flat transparent plate 4, which may be either a glass or a plastic plate. Alternatively, the translucent reflective film 5 can be placed directly on a front side of the display screen 7 of the video display device 2. Also, the translucent reflective film 5 described above can even be combined with the flat transparent plate 4 to form a tinted glass or tinted plastic plate.

With continued reference to FIG. 1A and by way of illustration, a displayed image 10 is produced on the display screen 7 of the video display device 2, indicated by an auxiliary dashed arrow. A displayed image light beam 10a with a displayed image light intensity I_{d}, of the displayed image 10, goes through the translucent reflective film 5 and the flat transparent plate 4 with partial transmission, and emerges as a displayed image transmitted light beam 10c with a transmitted display image light intensity I_{dt} being sensed by a user's eye 15 with a formation of a displayed image formation in user's eye 10g.

Simultaneously, an ambient object light beam 12a with an ambient object light intensity Iₐ of an ambient object 12 travels toward the dual function mirror segment 1. The ambient object light beam 12a gets partially reflected, by the multilayer structure comprising the flat transparent plate 4, the translucent reflective film 5 and the display screen 7, into an ambient object reflected light beam 12c with a reflected ambient object light intensity Iₐᵣ being sensed by a user's eye 15 with a formation of an ambient object image formation in user's eye 12g. At the same time, an ambient object transmitted light beam 12b goes through the afore-mentioned multilayer structure and impinges upon the display screen 7. While both the displayed image 10 and the ambient object 12 are illustrated herein with a physical object for convenience, it is remarked that in reality either one or both of them can be just a distributed light source with a variety of spectral compositions.

As the user's eye 15 senses both the transmitted display image light intensity I_{dt} and the reflected ambient object light intensity Iₐᵣ, the net image perception of a user of the dual function mirror segment 1 depends upon the relative intensities of the transmitted display image light intensity I_{dt} and the reflected ambient object light intensity Iₐᵣ and this is graphically illustrated in FIG. 1B which shows the underlying physics of operation of the dual function mirror segment 1.

For convenience, a visually relevant image-to-ambient contrast Cᵢₐ, is defined in the following way:

Cᵢₐ=I_{dt}/Iₐᵣ (1)

Under a condition of constant transmitted display image light intensity I_{dt}, FIG. 1B is a plot of a linearly increasing range of reflected ambient object light intensity Iₐᵣ.

Thus, toward the left side of FIG. 1B marked with a Display Operating Point (DOP) the following condition exists:

I_{dt}>>Iₐᵣ thus Cᵢₐ>>1.

As a result, the net image perception of a user of the dual function mirror segment 1 is dominated by the displayed image formation in the user's eye, illustrated in solid lines, with a weak superposition of the ambient object image formation in the user's eye, illustrated in dashed lines. This is a very desirable condition of the operation of the dual function mirror segment 1.

Toward the right side of FIG. 1B marked with a Reflective Operating Point (ROP) the following condition exists:

I_{dt}<<Iₐᵣ thus Cᵢₐ<<1.

As a result, the net image perception of a user of the dual function mirror segment 1 is dominated by the ambient object image formation in the user's eye, illustrated in solid lines, with a weak superposition of the displayed image formation in the user's eye, illustrated in dashed lines. This is clearly a very undesirable condition of the operation of the dual function mirror segment 1.

At the middle of FIG. 1B, marked with a Cross Over Point (COP), the following condition exists:

I_{dt}=Iₐᵣ thus Cᵢₐ=1.

As a result, the net image perception of a user of the dual function mirror segment 1 is a blurred superposition of both the displayed image formation and the ambient object image formation in the user's eye, both illustrated in dashed lines. This is also a very undesirable condition of the operation of the dual function mirror segment 1.

For those skilled in the art, it should become clear now that, within the middle zone of FIG. 1B where it is marked with a Cross Over Zone (COZ) the following condition exists:

I_{dt}˜Iₐᵣ thus Cᵢₐ˜1

and this is also an undesirable condition of the operation of the dual function mirror segment 1. Therefore, the present invention is directed to an dual function mirror suitable for providing alternatively or simultaneously both a conventional reflected image and a video image under a wide range of ambient lighting condition which satisfies the following condition:

Cᵢₐ>>1

by either increasing I_{dt} or decreasing Iₐᵣ or performing both actions when necessary. It is remarked that, in practice for most average users, a Cᵢₐ>=1.5 is found to be satisfactory.

In an application environment where there exists a wide variety of surrounding ambient lighting conditions, including variations in light intensity and direction, sometimes the two way, rear view mirror of the prior art exhibits an insufficient video image contrast for a clear view, particularly in the presence of exceptionally high ambient light intensity. This problem is especially serious when the direction of the already intense ambient light causes a specular reflection of the ambient light into the eyes of a user.

As can be seen, there is a need for an adjustable dual function mirror with video display operable to function either alternatively or simultaneously as an ordinary reflective mirror and a video display under a variety of ambient lighting conditions.

### SUMMARY OF THE INVENTION

In accordance with the present invention, an adjustable dual function mirror includes a plate including a smooth surface and a video display device disposed in spaced relationship to the plate, the plate and video display device being rotatable about at least one axis.

In accordance with another embodiment of the invention, an adjustable dual function mirror includes a reflective mirror segment and a dual function mirror segment connected to the reflective mirror segment, the dual function mirror segment including a plate having a smooth surface and a video display device disposed in spaced relationship to the plate, the dual function mirror segment being rotatable about at least one axis relative to the reflective mirror segment.

In accordance with yet another embodiment of the invention, an adjustable dual function mirror includes a reflective mirror segment and a dual function mirror segment connected to the reflective mirror segment, the dual function mirror segment including a plate having a smooth surface and a video display device disposed in spaced relationship to the plate.

These and other features, aspects and advantages of the present invention will become better understood with reference to the following drawings, description and claims.

### BRIEF DESCRIPTION OF THE DRAWINGS

FIG. 1A is a side perspective view of a prior art dual function mirror including images, light beams and a user's eye;

FIG. 1B is a graphical illustration of the underlying physics of operation of the dual function mirror in FIG. 1A;

FIGS. 2A, 2B and 2C illustrate an important effect on a visually relevant image-to-ambient contrast resulting from a rotation of the dual function mirror;

FIGS. 2D and 2E illustrate the same effect as shown in FIGS. 2A, 2B and 2C except that a nonessential backside casing element as illustrated in FIG. 1A is eliminated;

FIGS. 3A and 3B illustrate a typical non-uniform distribution of ambient lighting intensity within a vehicle;

FIGS. 4A, 4B and 4C illustrate an embodiment of the present invention wherein a dual function mirror segment is shown disposed in lateral spaced relationship to a traditional mirror segment and rotationally adjustable about a first axis and a second axis;

FIG. 4D illustrates an embodiment of the present invention wherein a curvable dual function mirror segment is shown disposed in lateral spaced relationship to a traditional mirror segment;

FIGS. 5A, 5B and 5C illustrate another embodiment of the present invention wherein a dual function mirror segment is shown disposed in medial spaced relationship to a traditional mirror segment and rotationally adjustable about a first axis and a second axis;

FIGS. 5D, 5E and 5F illustrate a few detailed examples of devices for rotationally adjusting a dual function mirror segment of the present invention;

FIGS. 6A, 6B and 6C illustrate a third embodiment of the present invention wherein a dual function mirror end segment includes an added interposed position adjustable variable transmissivity screen;

FIGS. 7A and 7B illustrate a fourth embodiment of the present invention wherein a dual function mirror end segment includes an electrically controllable variable transmissivity film; and

FIGS. 8A and 8B illustrate a fifth embodiment of the present invention wherein a dual function mirror end segment includes a surface-roughness controllable variable-reflectivity film.

### DETAILED DESCRIPTION OF THE INVENTION

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or an “embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

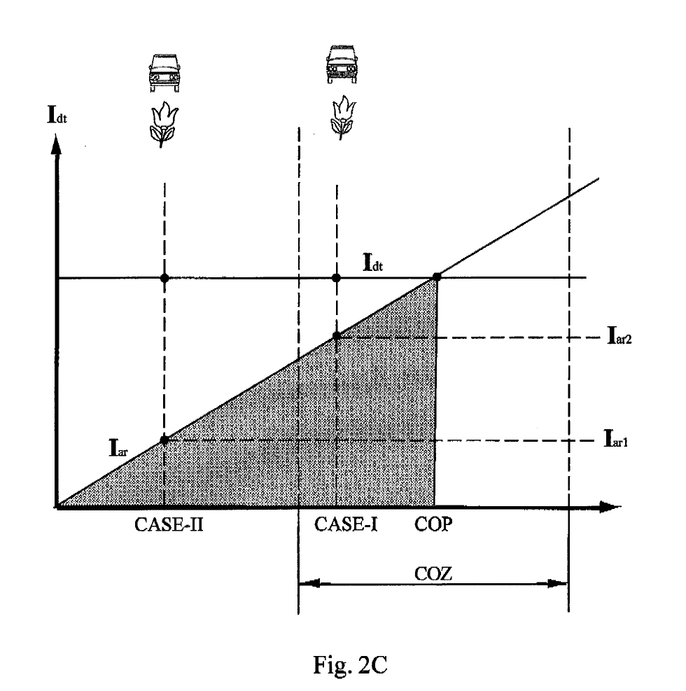

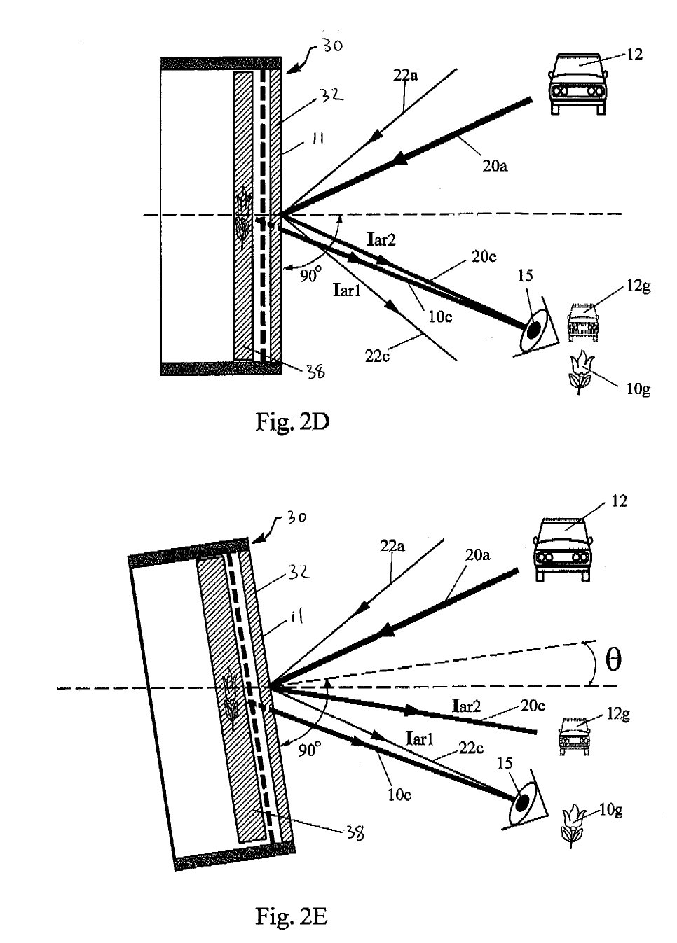

In accordance with the present invention and with reference to FIGS. 2A and 2B, an adjustable dual function mirror generally designated 30 includes a plate 32 which may include a smooth surface 11. Although shown as generally flat, smooth surface 11 may be curved.

In a preferred embodiment of the invention, the plate 32 may include a single layer, multiple layers or no layers of a translucent reflective film 34. In other preferred embodiments, the plate 32 may be coated by chemical or other conventional means. Tinting of the plate 32 may be achieved by chemical bonding or by other conventional methods.

In further preferred embodiments of the invention, a casing 36 may be disposed in any relationship to the plate 32. Furthermore, a video display device 38 may be positioned in any spaced relationship to the plate 32.

FIGS. 2A and 2B show a side view of the dual function mirror 30 according to an embodiment of the invention, wherein an important effect of rotation of the dual function mirror 30 on the visually relevant image-to-ambient contrast, Cᵢₐ, is shown. With reference to FIG. 2A, (referred to herein as CASE-I), the plate 32 of a dual function mirror 30 is oriented in a vertical plane. The ambient lighting condition, among other things, comprises a strong ambient object light beam 20a and a weak ambient object light beam 22a, both signified with their respective thickness of light beams. The same convention will be followed throughout the rest of the specification to signify the relative intensity of a light beam. Correspondingly, a strong ambient object reflected light beam 20c with a strong reflected ambient object light intensity Iₐᵣ₂ hits the user's eye 15 while a weak ambient object reflected light beam 22c with a weak reflected ambient object light intensity Iₐᵣ₁ misses the user's eye 15. For clarity of illustration, the transmitted display image light intensity I_{dt} is omitted from FIGS. 2A and 2B. Given the various light intensities shown, the corresponding operating point, CASE-I, is illustrated in FIG. 2C. As CASE-I falls within the COZ, this is an undesirable condition of the operation of the dual function mirror 30 and is graphically illustrated with a dashed displayed image formation in user's eye 10g and a dashed ambient object image formation in user's eye 12g.

With reference to FIG. 2B, (referred to herein as CASE-II), the plate 32 of a dual function mirror 30 is rotated from the vertical plane by an angle θ. As a result, the strong ambient object reflected light beam 20c with a strong reflected ambient object light intensity Iₐᵣ₂ misses the user's eye 15 while the weak ambient object reflected light beam 22c with a weak reflected ambient object light intensity Iₐᵣ₁ hits the user's eye 15. Given the various light intensities shown, the corresponding operating point, CASE-II, is illustrated in FIG. 2C. As CASE-II now falls outside the COZ with I_{dt}>>Iₐᵣ, this means Cᵢₐ>>1 and CASE-II has become a desirable condition of the operation of the dual function mirror 30, which is graphically illustrated with a solid displayed image formation in user's eye 10g and a dashed ambient object image formation in user's eye 12g. It is important to remark that, while the angle of rotation θ does also affect the light intensity I_{dt} of the transmitted display image under a typical application environment where the video display device 38 is capable of providing a wide viewing angle coupled with a fairly limited angle of rotation, such as less than 45 degrees, the corresponding variation of I_{dt} is comparatively small compared to that of the Iₐᵣ. Therefore, by properly adjusting the angular orientation of the dual function mirror 30 with respect to a user, an optimal Cᵢₐ can be achieved for viewing under a variety of surrounding ambient lighting directions and intensities.

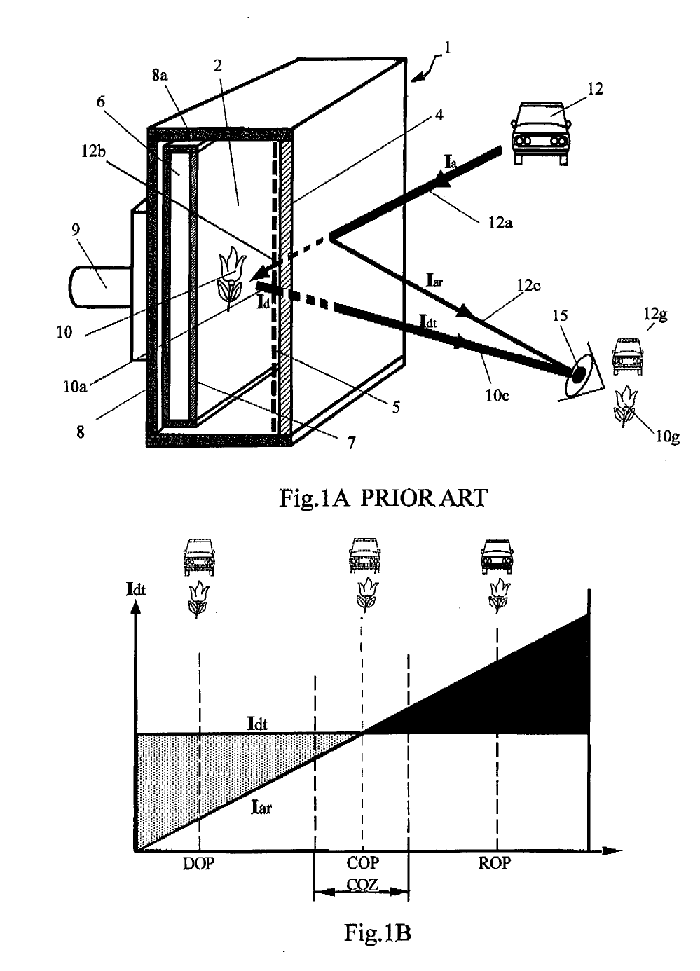

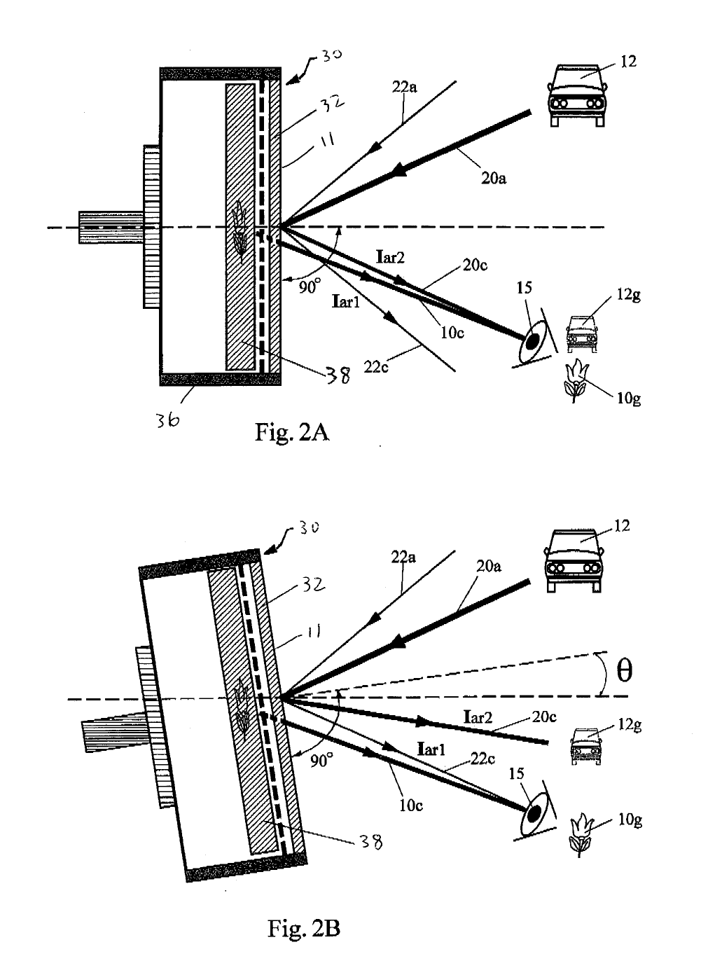

FIGS. 2D and 2E illustrate the same effect as just illustrated in FIGS. 2A, 2B and FIG. 2C on the visually relevant image-to-ambient contrast Cᵢₐ from a rotation of the dual function mirror 30 except that a nonessential backside casing element (i.e., the reference numeral 8 of FIG. 1A) of the dual function mirror 30 is eliminated. For those skilled in the art, it should be clear that while the backside casing element can be optionally included in the dual function mirror 30 for increased structural rigidity or cosmetic considerations, the presence of the backside casing element is really not essential for the just illustrated effect whereby an optimal Cia can be achieved for viewing under a variety of surrounding ambient lighting directions and intensities.

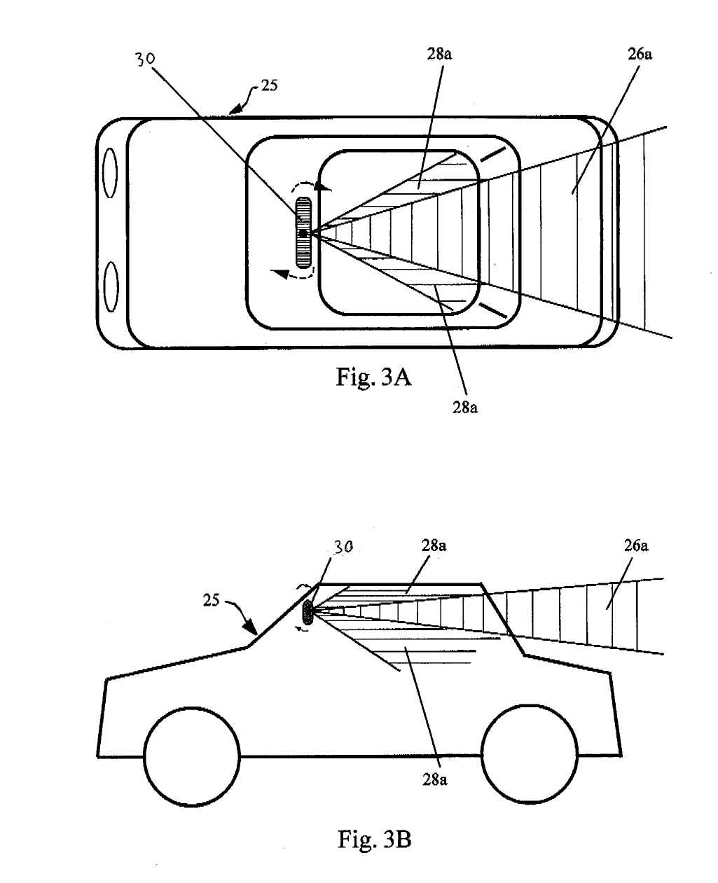

FIGS. 3A and 3B illustrate a variety of directions and intensities of surrounding ambient lighting conditions within an automobile 25 for the application of the dual function mirror 30 with the technique of angular adjustment as just described. In FIG. 3A due to the conventional frame structure of the automobile 25, a strong ambient light zone 26a surrounded by two weak ambient light zones 28a are typically formed within a horizontal plane intersecting the dual function mirror 30. Thus, the dual function mirror 30 needs to be angularly adjusted around a vertical axis as illustrated. In FIG. 3B, due to the conventional roof and frame structure of the automobile 25, a strong ambient light zone 26a surrounded by two weak ambient light zones 28a are typically formed within a vertical plane intersecting the dual function mirror segment 1. Thus, the dual function mirror segment 1 needs to be angularly adjusted around a horizontal axis as illustrated.

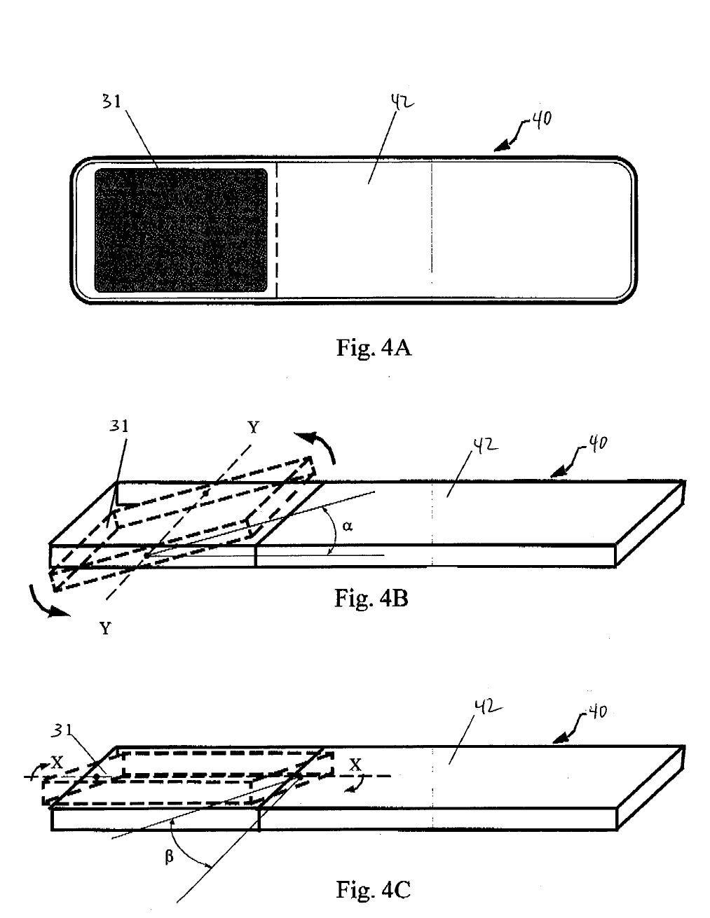

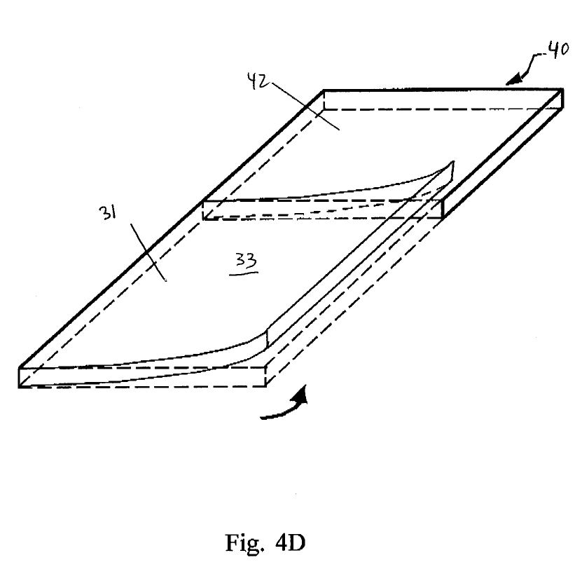

FIGS. 4A, 4B and 4C illustrate an embodiment of the present invention including a two piece mirror generally designated 40. With reference to FIG. 4A the two piece mirror 40 is shown including a dual function mirror segment 31 having the features of dual function mirror 30 laterally disposed at a left end of the two piece mirror 40 and connected to a traditional mirror segment 42. Such connection may be accomplished by any convention method well known in the art including magnetic suspension and flexible connectors including soft rubber or silicone connectors. Furthermore, such connection may or may not include a gap between the dual function mirror segment 31 and the traditional mirror segment 42.

In FIG. 4B the dual function mirror segment 31 is connected to the two piece mirror 40 through a first axis Y-Y for the rotational adjustment, at an angle α, of the dual function mirror segment 31. In FIG. 4C the dual function mirror segment 31 is connected to the two piece mirror 40 through a second axis X-X for the rotational adjustment, at an angle β, of the dual function mirror segment 31.

With reference to FIG. 4D, the dual function mirror segment 31 is shown having a curved surface 33. Curved surface 33 may be achieved by providing plate 31 with a curved surface or by making plate 31 with flexible materials so that the plate 31 can be curved by conventional mechanical or electromechanical means.

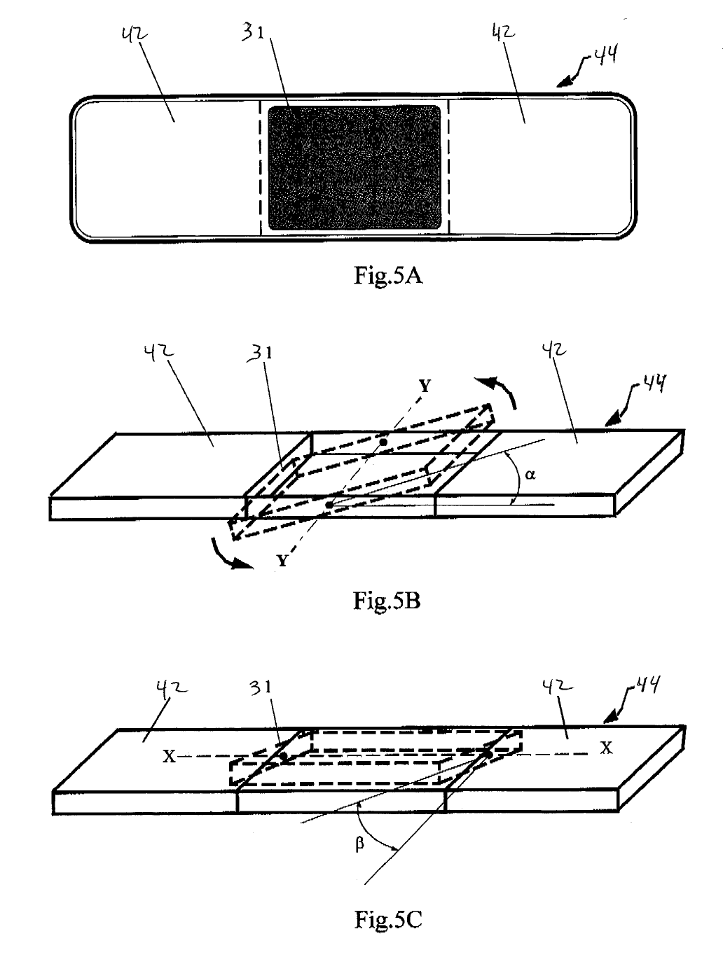

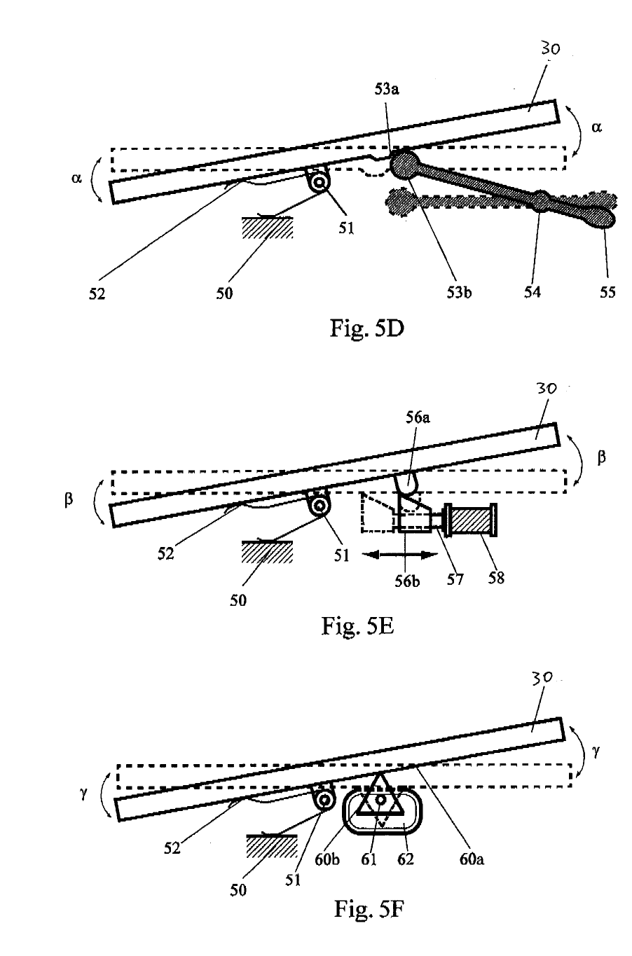

FIGS. 5A, 5B and 5C illustrate another embodiment of the present invention including a mirror generally designated 44. In FIG. 5A the mirror 44 is shown including the dual function mirror segment 31 medially connected between two traditional mirror segments 42. In FIG. 5B the dual function mirror segment 31 is connected to the rest of the mirror 44 through a first axis Y-Y for the rotational adjustment, at an angle α, of the dual function mirror segment 31. In FIG. 5C the dual function mirror segment 31 is connected to the rest of the mirror 44 through a second axis X-X for the rotational adjustment, at an angle β, of the dual function mirror segment 31. By now it should be clear that a variety of combinations of the number and locations of dual function mirror segments 31 and traditional mirror segments 42 and the orientation of rotational axes for each of the dual function mirror segments 31 can be implemented using the same principle of operation as described. In fact, a simultaneous multiple axis rotation can be implemented for the dual function mirror segment 31 using, for example, a gimbal-mount structure.

Referring now to FIGS. 5D, 5E and 5F, a few detailed devices for rotationally adjusting the dual function mirror segment 30 and dual function mirror segment 31 (not shown) of the present invention are illustrated. The rest of the details of the dual function mirror 30 are not shown here to avoid any unnecessary obscuring details. In FIG. 5D the dual function mirror 30 may be pivotally mounted onto a fixed frame surface 50 through a combination of a pivot axis 51 and a torsion spring 52. The dual function mirror 30 has an integrated engaging tab 53a that slidably engages an engaging curved cam 53b of a handle bar 55 that is manually and rotationally operated around a rotation axis 54 to effect an angle of rotation α.

The device shown in FIG. 5E is similar to that shown in FIG. 5D except that an engaging tab member 56a of the dual function mirror 30 works in sliding contact with an engaging sloped cam 56b that is in turn rigidly connected to a reciprocating plunger 57 of an electromagnetic relay 58 electrically activated to effect an angle of rotation β.

The device shown in FIG. 5F is also similar to that of FIG. 5D except that a back surface 60a of the dual function mirror 30 works in sliding contact with a triangular cam 60b that is in turn rigidly connected to a rotation axis 61 driven by a motor 62 electrically controlled to effect an angle of rotation γ. Additionally, although not graphically shown here to avoid unnecessary details, there are numerous mechanical, fluid dynamical and electrical ways to rotationally adjust the dual function mirror 30. For example, a pneumatically controlled cam, a linear-to-rotation linkage driven by an electromechanical relay and a computer-controlled stepper motor can all be employed to effect the desired rotational adjustment.

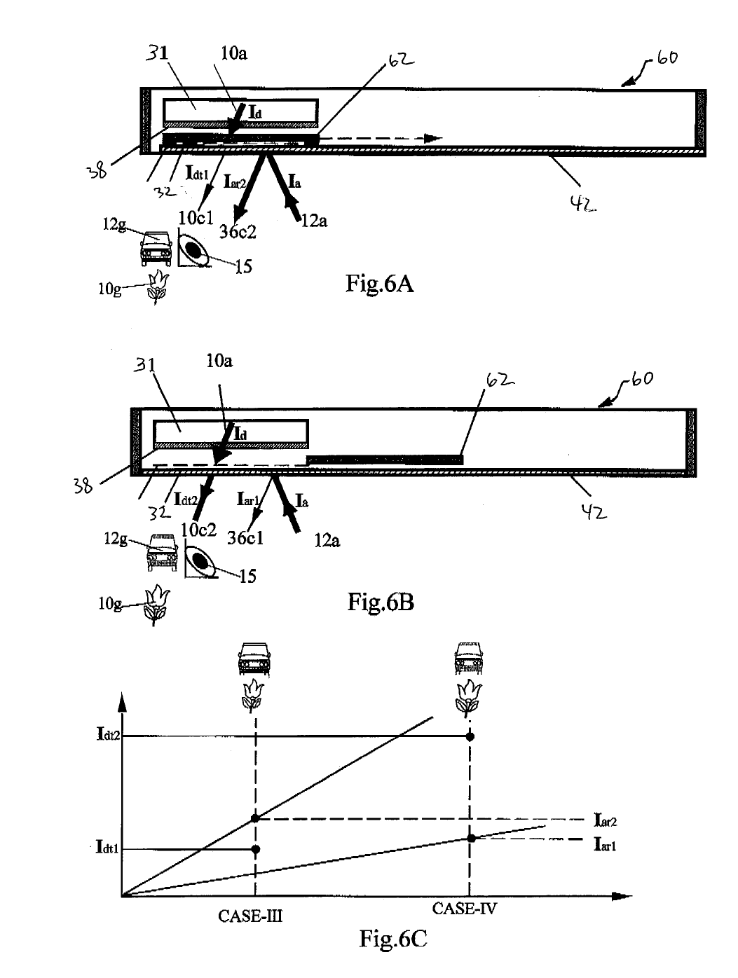

FIGS. 6A, 6B and 6C illustrate a third embodiment of the present invention including a mirror generally designated 60. In FIG. 6A (referred to herein as CASE-III), the mirror 60 is shown including a dual function mirror segment 31 at the left end connected to a traditional mirror segment 42. A position adjustable variable transmissivity screen 62 is interposed between video display device 38 and the plate 32. With the adjustable variable transmissivity screen 62 placed directly in front of the video display device 38, the position adjustable variable transmissivity screen 62 acts both as a layer to increase the composite reflectivity of the dual function mirror segment 31 for an ambient object light beam 12a with an ambient object light intensity Iₐ and as a layer to decrease the composite transmissivity for a displayed image light beam 10a with a displayed image light intensity I_{d}. Thus, the correspondingly reflected and transmitted lights from the dual function mirror segment 31 are a strong ambient object reflected light beam 36c2 with a strong reflected ambient object light intensity Iₐᵣ₂ and a weak displayed image transmitted light beam 10c1 with a weak transmitted display image light intensity I_{dt1}. Given the various light intensities shown, the corresponding operating point, CASE-III, is illustrated in FIG. 6C. As I_{dt1}<Iₐᵣ₂ and thus Cᵢₐ<1, this is an undesirable condition of the operation of the mirror 60 that is graphically illustrated with a dashed displayed image formation in user's eye 10g and a solid ambient object image formation in user's eye 12g.

In FIG. 6B, (referred to herein as CASE-IV), the adjustable variable transmissivity screen 62 is moved away from the front of the video display device 38 thus decreasing the composite reflectivity of the dual function mirror segment 31 for an ambient object light beam 12a with an ambient object light intensity Iₐ while increasing the composite transmissivity for a displayed image light beam 10a with a displayed image light intensity I_{d}. Thus, the correspondingly reflected and transmitted lights from the dual function mirror segment 31 become a weak ambient object reflected light beam 36c1 with a weak reflected ambient object light intensity Iₐᵣ₁ and a strong displayed image transmitted light beam 10c2 with a strong transmitted display image light intensity I_{dt2}.

Referring to FIG. 6C, the corresponding operating point, CASE-IV, is illustrated. As I_{dt2}>>Iₐᵣ₁ and thus Cᵢₐ>>1, this has now become a desirable condition of the operation of the mirror 60 and it is graphically illustrated with a solid displayed image formation in user's eye 10g and a dashed ambient object image formation in user's eye 12g. Therefore, by properly adjusting the position of an added interposed adjustable variable transmissivity screen 62 relative to the dual function mirror segment 31 of the mirror 60, an optimal Cᵢₐ can be achieved for viewing under a variety of surrounding ambient lighting conditions. As a variation, a position adjustable variable transmissivity screen (not shown) can instead be made of a number of adjacent sections each with a successively different light transmissivity followed by a corresponding section-by-section movement to effect an adjustment of Cᵢₐ with a finer resolution. Furthermore, although not shown here to avoid unnecessarily obscuring details, there are numerous mechanical, fluid dynamical and electrical ways to implement the desired linear movement of the position adjustable variable transmissivity screen 62. For example, a manually operated mechanical lever coupled with a multiple position detent, a pneumatically driven piston with an automatic spring return to a normal position, an electromechanical relay and a computer-controlled linear motor can all be employed to effect the linear movement.

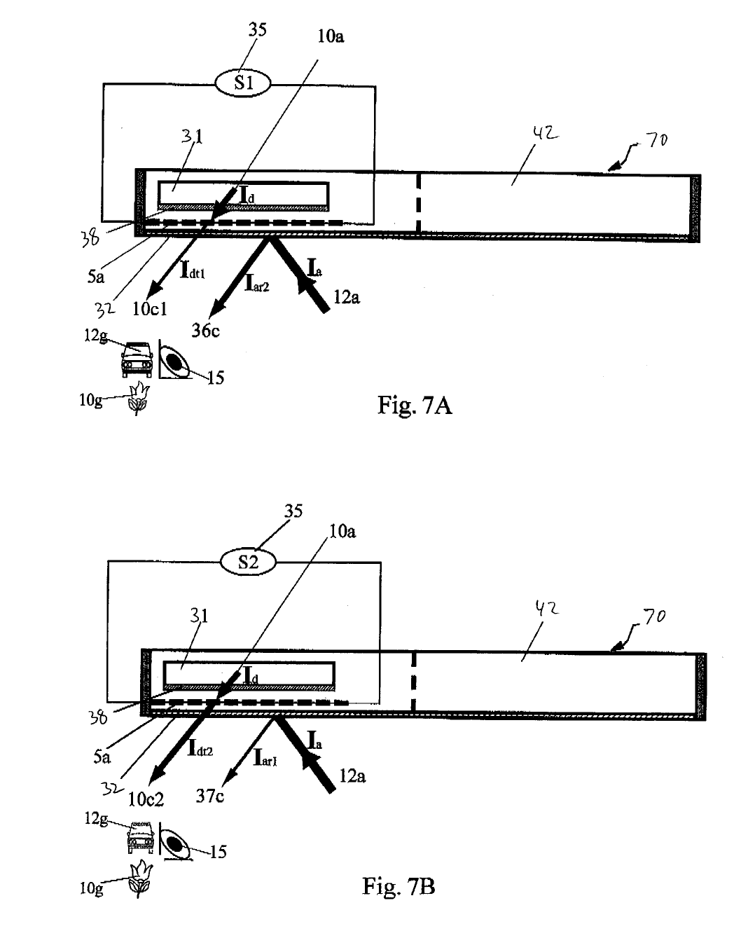

FIGS. 7A and 7B illustrate a fourth embodiment of the present invention including a mirror 70. In FIG. 7A, (referred to herein as CASE-V), the mirror 70 is shown including a dual function mirror segment 31 at the left end connected to a traditional mirror segment 42. A controllable variable transmissivity LCD (Liquid Crystal Display) film 5a, electrically driven by an external modulation signal source 35 set at signal level S1, is disposed between video display device 38 and the plate 32. The controllable variable transmissivity LCD film 5a, comprising a two-dimensional matrix of electrically connected LCD pixels, exhibits a variable light transmissivity that is a function of the signal level of the modulation signal source 35. For the purpose of a simple illustration of the present invention, assuming that (1) at signal level S1, the controllable variable transmissivity LCD film 5a exhibits a low transmissivity and (2) at signal level S2, the controllable variable transmissivity LCD film 5a exhibits a high transmissivity, notice that, accompanying a low transmissivity, the controllable variable transmissivity LCD film 5a naturally exhibits a high reflectivity and vice versa. It follows that, in FIG. 7A (CASE-V) wherein the signal level of the modulation signal source 35 is S1, a weak displayed image transmitted light beam 10c1 with a weak transmitted display image light intensity I_{dt1} is accompanied by a strong ambient object reflected light beam 36c with a strong reflected ambient object light intensity Iar2, an undesirable operating condition, with Cia<1, of the mirror 70 is created. However, in FIG. 7B (CASE-VI) wherein the signal level of the modulation signal source 35 is switched to S2, a strong displayed image transmitted light beam 10c2 with a strong transmitted display image light intensity Idt2 is now accompanied by a weak ambient object reflected light beam 37c with a weak reflected ambient object light intensity Iar1, a desirable operating condition, with Cia>>1, of the mirror 70 is achieved. Therefore, by properly controlling the transmissivity of a controllable variable transmissivity film, an optimal Cia can be achieved for viewing under a variety of surrounding ambient lighting conditions. Notice that the controllable variable transmissivity LCD film 5a can be equivalently implemented with a variety of alternative means whereby a variable transmissivity is produced by a corresponding adjustment of a signal level of the external modulation signal source 35. For example, an electrically controlled light gate or grating should both work well.

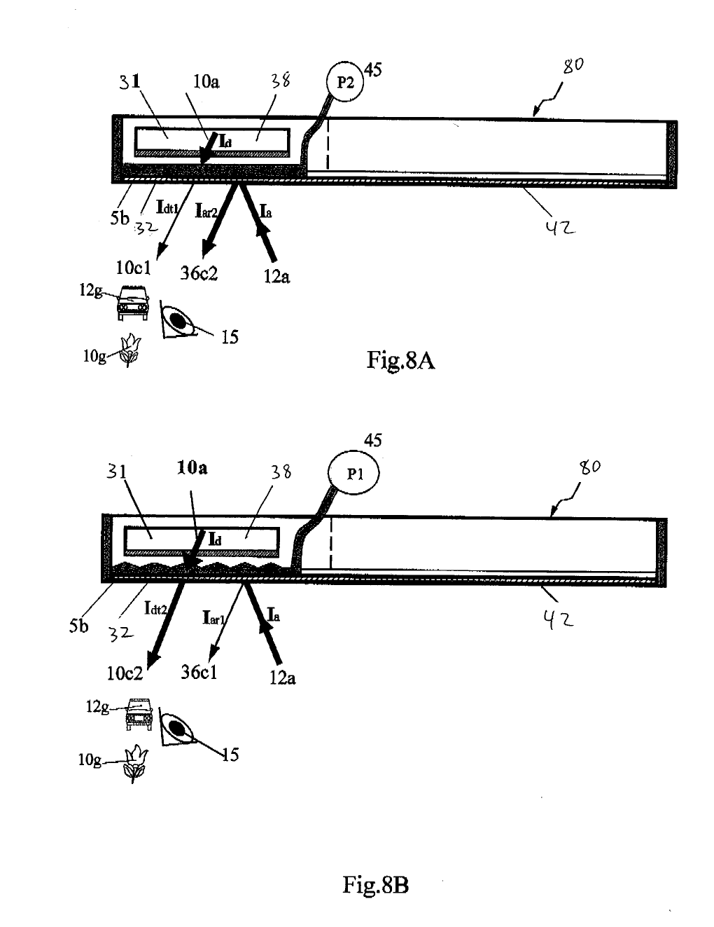

FIGS. 8A and 8B illustrate a fifth embodiment of the present invention including a mirror 80. In FIG. 8A the mirror 80 is shown including a dual function mirror segment 31 at the left end connected to a traditional mirror segment 42. A surface-roughness controllable variable-reflectivity film 5b, pressurized by an external controllable pressure source 45, is placed between video display device 38 and the plate 32. The surface-roughness controllable variable-reflectivity film 5b, made of a hollow elastomeric film pouch with an integral surface texture that diminishes, with a resulting increase of its reflectivity, with an increased internal air pressure exerted by the controllable pressure source 45. For the purpose of a simple illustration of the present invention, assuming that (1) under pressure p₂, the surface-roughness controllable variable-reflectivity film 5b exhibits a high reflectivity and (2) under pressure p₁, the surface-roughness controllable variable-reflectivity film 5b exhibits a low reflectivity, notice that, accompanying a high reflectivity, the surface-roughness controllable variable-reflectivity film 5b naturally exhibits a low transmissivity and vice versa. It follows that, in FIG. 8A wherein the pressure of the controllable pressure source 45 is p₂, a weak displayed image transmitted light beam 10c1 with a weak transmitted display image light intensity I_{dt1} is accompanied by a strong ambient object reflected light beam 36c with a strong reflected ambient object light intensity Iₐᵣ₂, an undesirable operating condition, with Cᵢₐ<1, of the mirror 80 is created. However, in FIG. 8B wherein the pressure of the controllable pressure source 45 is reduced to p₁, a strong displayed image transmitted light beam 10c2 with a strong transmitted display image light intensity I_{dt2} is now accompanied by a weak ambient object reflected light beam 37c with a weak reflected ambient object light intensity Iₐᵣ₁, a desirable operating condition, with Cᵢₐ>>1, of the mirror 80 is achieved. Therefore, by properly controlling the reflectivity of a surface-roughness controllable variable-reflectivity film, an optimal Cᵢₐ can be achieved for viewing under a variety of surrounding ambient lighting conditions. Notice that there are, other than through the control of surface-roughness as illustrated, many alternative ways to achieve a film with variable reflectivity. For example, a surface-curvature controllable variable-reflectivity film can be made of a thin transparent metallic film pouch wherein one pouch surface would form a slight bulge under an internal pressure. Another surface-curvature controllable variable-reflectivity film can be made of a thin transparent metallic film pouch wherein one pouch surface would cave in slightly under a partial internal vacuum. A third example is a surface-tilt controllable variable-reflectivity film made of a thin transparent metallic film pouch wherein one pouch surface has a gradient wall thickness so that it would undergo a slight tilt under an internal pressure. However, accompanying these alternative ways of implementation, there are associated directional changes of the reflected light as well which must be compensated for to control the Cᵢₐ as was already explained with reference to FIGS. 2A, 2B and 2C. Furthermore, although not shown here to avoid unnecessarily obscuring details, there are numerous mechanical, fluid dynamical and electrical ways to implement the controllable pressure source 45. For example, a lever operated pneumatic piston coupled with a multiple position detent, a pneumatically driven piston with an automatic spring return to a normal position and a computer-controlled air pump are all candidates for consideration.

As illustrated and described with numerous preferred embodiments, a dual function mirror including a number of traditional mirror segments and at least one dual function mirror segment is operable to provide alternatively or simultaneously both a conventional reflected image and a video image with an optimal visually relevant image-to-ambient contrast Cᵢₐ under a wide range of ambient lighting conditions. Those skilled in the are will appreciate that the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principles. The scope of the claims, therefore, should be accorded the broadest interpretations so as to encompass all such modifications and similar arrangements.

I claim:

1. An adjustable dual function mirror comprising:
a plate including a smooth surface; and
a video display device disposed in spaced relationship to the plate, the plate and video display device being rotatable about at least one axis.

2. The adjustable dual function mirror of claim 1, wherein the plate further comprises a single layer of reflective film.

3. The adjustable dual function mirror of claim 1, wherein the plate further comprises multiple layers of reflective film.

4. The adjustable dual function mirror of claim 1, wherein the plate further comprises a tinted plate.

5. The adjustable dual function mirror of claim 1, wherein the plate further comprises a coated plate.

6. The adjustable dual function mirror of claim 1, wherein the plate further comprises a curvable plate.

7. The adjustable dual function mirror of claim 1, wherein the smooth surface is curved.

8. The adjustable dual function mirror of claim 1, wherein the smooth surface is variably curvable.

9. The adjustable dual function mirror of claim 1, wherein the video display device is disposed directly behind the plate.

10. The adjustable dual function mirror of claim 1, further comprising a variable transmissivity screen movably interposed between the plate and the video display device.

11. The adjustable dual function mirror of claim 1, further comprising a variable transmissivity film interposed between the plate and the video display device.

12. The adjustable dual function mirror of claim 11, wherein the variable transmissivity film is electrically controllable.

13. The adjustable dual function mirror of claim 1, further comprising a variable transmissivity means interposed between the plate and the video display device.

14. The adjustable dual function mirror of claim 13, wherein the variable transmissivity means further comprises a controllable variable transmissivity liquid crystal display.

15. The adjustable dual function mirror of claim 1, further comprising a variable reflectivity film interposed between the plate and the video display device.

16. The adjustable dual function mirror of claim 1, further comprising a variable reflectivity means interposed between the plate and the video display device.

17. The adjustable dual function mirror of claim 16, wherein the variable reflectivity means further comprises a surface roughness controllable variable reflectivity film.

18. The adjustable dual function mirror of claim 16, wherein the variable reflectivity means further comprises a surface curvature controllable variable reflectivity film.

19. The adjustable dual function mirror of claim 18, wherein the surface curvature controllable variable reflectivity film further comprises a pressure controllable pouch.

20. The adjustable dual function mirror of claim 16, wherein the variable reflectivity means further comprises a surface tilt controllable variable reflectivity film.

21. The adjustable dual function mirror of claim 20, wherein the surface tilt controllable variable reflectivity film further comprises a pressure controllable pouch.

22. An adjustable dual function mirror comprising:
a reflective mirror segment; and
a dual function mirror segment connected to the reflective mirror segment, the dual function mirror segment including a plate having a smooth surface and a video display device disposed in spaced relationship to the plate, the dual function mirror segment being rotatable about at least one axis relative to the reflective mirror segment.

23. The adjustable dual function mirror of claim 22, wherein the dual function mirror segment is connected to the reflective mirror segment magnetically.

24. The adjustable dual function mirror of claim 22, wherein the dual function mirror segment is connected to the reflective mirror segment with flexible connectors.

25. The adjustable dual function mirror of claim 22, wherein the dual function mirror segment is connected to the reflective mirror segment such that a gap is disposed therebetween.

26. The adjustable dual function mirror of claim 22, wherein the dual function mirror segment is connected to the reflective mirror segment such that no gap is disposed therebetween.

27. The adjustable dual function mirror of claim 22, wherein the plate further comprises one layer of reflective film.

28. The adjustable dual function mirror of claim 22, wherein the plate further comprises multiple layers of reflective film.

29. The adjustable dual function mirror of claim 22, wherein the plate further comprises a tinted plate.

30. The adjustable dual function mirror of claim 22, wherein the plate further comprises a coated plate.

31. The adjustable dual function mirror of claim 22, wherein the plate further comprises a curvable plate.

32. The adjustable dual function mirror of claim 22, wherein the smooth surface is curved.

33. The adjustable dual function mirror of claim 22, wherein the smooth surface is variably curvable.

34. The adjustable dual function mirror of claim 22, wherein the video display device is disposed directly behind the plate.

35. The adjustable dual function mirror of claim 22, further comprising a variable transmissivity screen movably interposed between the plate and the video display device.

36. The adjustable dual function mirror of claim 22, further comprising a variable transmissivity film interposed between the plate and the video display device.

37. The adjustable dual function mirror of claim 22, further comprising a variable transmissivity means interposed between the plate and the video display device.

38. The adjustable dual function mirror of claim 37, wherein the variable transmissivity means further comprises an electrically controllable variable transmissivity liquid crystal display.

39. The adjustable dual function mirror of claim 22, further comprising a variable reflectivity film interposed between the plate and the video display device.

40. The adjustable dual function mirror of claim 22, further comprising a variable reflectivity means interposed between the plate and the video display device.

41. The adjustable dual function mirror of claim 40, wherein the variable reflectivity means further comprises a surface roughness controllable variable reflectivity film.

42. The adjustable dual function mirror of claim 40, wherein the variable reflectivity means further comprises a surface curvature controllable variable reflectivity film.

43. The adjustable dual function mirror of claim 42, wherein the surface curvature controllable variable reflectivity film further comprises a pressure controllable pouch.

44. The adjustable dual function mirror of claim 40, wherein the variable reflectivity means further comprises a surface tilt controllable variable reflectivity film.

45. The adjustable dual function mirror of claim 44, wherein the surface tilt controllable variable reflectivity film further comprises a pressure controllable pouch.

46. An adjustable dual function mirror comprising:
a reflective mirror segment; and
a dual function mirror segment connected to the reflective mirror segment, the dual function mirror segment including a plate having a smooth surface and a video display device disposed in spaced relationship to the plate.

47. The adjustable dual function mirror of claim 46, wherein the plate further comprises one layer of reflective film.

48. The adjustable dual function mirror of claim 46, wherein the plate further comprises multiple layers of reflective film.

49. The adjustable dual function mirror of claim 46, wherein the plate further comprises a tinted plate.

50. The adjustable dual function mirror of claim 46, wherein the plate further comprises a coated plate.

51. The adjustable dual function mirror of claim 46, wherein the plate further comprises a curvable plate.

52. The adjustable dual function mirror of claim 46, wherein the smooth surface is curved.

53. The adjustable dual function mirror of claim 46, wherein the smooth surface is variably curvable.

54. The adjustable dual function mirror of claim 46, wherein the video display device is disposed directly behind the plate.

55. The adjustable dual function mirror of claim 46, further comprising a variable transmissivity screen movably interposed between the plate and the video display device.

56. The adjustable dual function mirror of claim 46, further comprising a variable transmissivity film interposed between the plate and the video display device.

57. The adjustable dual function mirror of claim 46, further comprising a variable transmissivity means interposed between the plate and the video display device.

58. The adjustable dual function mirror of claim 57, wherein the variable transmissivity means further comprises an electrically controllable variable transmissivity liquid crystal display.

59. The adjustable dual function mirror of claim 46, further comprising a variable reflectivity film interposed between the plate and the video display device.

60. The adjustable dual function mirror of claim 46, further comprising a variable reflectivity means interposed between the plate and the video display device.

61. The adjustable dual function mirror of claim 60, wherein the variable reflectivity means further comprises a surface roughness controllable variable reflectivity film.

62. The adjustable dual function mirror of claim 60, wherein the variable reflectivity means further comprises a surface curvature controllable variable reflectivity film.

63. The adjustable dual function mirror of claim 62, wherein the surface curvature controllable variable reflectivity film further comprises a pressure controllable pouch.

64. The adjustable dual function mirror of claim 60, wherein the variable reflectivity means further comprises a surface tilt controllable variable reflectivity film.

65. The adjustable dual function mirror of claim 64, wherein the surface tilt controllable variable reflectivity film further comprises a pressure controllable pouch.
